(19) United States
(12) Patent Application Publication
(10) Pub. No.: US 2024/0176413 A1
(43) Pub. Date: May 30, 2024

(54) INFORMATION PROVIDING APPARATUS, INFORMATION PROCESSING SYSTEM, AND INFORMATION PROVIDING METHOD

(71) Applicants: Naoki CHIYO, Kanagawa (JP); Hidetoshi KIKUCHI, Tokyo (JP); Kohji YAMAMOTO, Kanagawa (JP)

(72) Inventors: Naoki CHIYO, Kanagawa (JP); Hidetoshi KIKUCHI, Tokyo (JP); Kohji YAMAMOTO, Kanagawa (JP)

(73) Assignee: Ricoh Company, Ltd., Tokyo (JP)

(21) Appl. No.: 18/521,616

(22) Filed: Nov. 28, 2023

(30) Foreign Application Priority Data
Nov. 30, 2022 (JP) 2022-192207
Nov. 30, 2022 (JP) 2022-192208

(51) Int. Cl. G06F 3/01; G06F 3/04815; G06Q 30/0601

(52) U.S. Cl. CPC G06F 3/011; G06F 3/04815; G06Q 30/0641

(57) ABSTRACT

An information providing apparatus includes circuitry; and a memory storing computer-executable instructions that cause the circuitry to execute acquiring behavior history information of a user in a first virtual space displayed on a user terminal operated by the user; and transmitting proposal information based on the behavior history information corresponding to attribute information of the user, as proposal information to be proposed to the user to whom a second virtual space is displayed.

### CROSS-REFERENCE TO RELATED APPLICATION

The present application is based on and claims priority under 35 U.S.C. § 119 to Japanese Patent Application No. 2022-192207, filed on Nov. 30, 2022 and Japanese Patent Application No. 2022-192208, filed on Nov. 30, 2022, the contents of which are incorporated herein by reference in their entirety.

### BACKGROUND OF THE INVENTION

### 1. Field of the Invention

The present invention relates to an information providing apparatus, an information processing system, and an information providing method.

### 2. Description of the Related Art

Recently, there has been an increase in what is referred to as electronic commerce (EC) sales, etc., in which individuals purchase commercial goods, etc., by using a computing technique of connecting to the Internet at any time or place. Furthermore, in recent years, it has become possible to view facilities in the Internet space by street view and purchase commercial goods sold at such facilities by using an Internet computing technique.

However, in the case of purchasing commercial goods by using the Internet computing technique on EC sites or virtual spaces in such conventional Internet spaces, there has been demand for a technique that can provide purchase experiences, etc., based on attribute information (e.g., preferences) that differs for each user among stores and in the entire facility.

### SUMMARY OF THE INVENTION

According to one aspect of the present invention, there is provided an information providing apparatus including circuitry; and a memory storing computer-executable instructions that cause the circuitry to execute acquiring behavior history information of a user in a first virtual space displayed on a user terminal operated by the user; and transmitting proposal information based on the behavior history information corresponding to attribute information of the user, as proposal information to be proposed to the user to whom a second virtual space is displayed.

### BRIEF DESCRIPTION OF THE DRAWINGS

FIG. 1 is a configuration diagram of an example of an information processing system according to an embodiment of the present invention;

FIG. 2 is a hardware configuration diagram of an example of a computer according to an embodiment of the present invention;

FIG. 3 is a hardware configuration diagram of an example of a smartphone according to an embodiment of the present invention;

FIG. 4 is a functional configuration diagram of an example of an information providing apparatus and a virtual space display apparatus according to an embodiment of the present invention;

FIG. 5 is a functional configuration diagram of an example of a user terminal according to an embodiment of the present invention;

FIG. 6 is a configuration diagram of an example of user information according to an embodiment of the present invention;

FIG. 7 is a configuration diagram of an example of coordination history information according to an embodiment of the present invention;

FIG. 8 is a configuration diagram of an example of behavior history information according to an embodiment of the present invention;

FIG. 9 is a configuration diagram of an example of interest level information according to an embodiment of the present invention;

FIG. 10 is a configuration diagram of an example of commercial goods information according to an embodiment of the present invention;

FIG. 11 is a flowchart illustrating an example of the registration process of the information processing system according to an embodiment of the present invention;

FIG. 12 is a flowchart illustrating an example of the service use processing of the information processing system according to an embodiment of the present invention;

FIG. 13 is an image diagram of an example of a store selection screen according to an embodiment of the present invention;

FIG. 14 is a flowchart of an example of a process for generating proposal information to a user according to an embodiment of the present invention;

FIG. 15 is a configuration diagram of an example of information used for determining a user's preference according to an embodiment of the present invention;

FIG. 16 is a diagram for explaining an example of a score for each commercial goods sold in a virtual store or a physical store displayed on a user terminal after moving to a store according to an embodiment of the present invention;

FIGS. 17A and 17B is an image diagram of an example of an image of a virtual store or a real store displayed on a user terminal according to an embodiment of the present invention;

FIG. 18 is a diagram for explaining the data structure of a blockchain according to an embodiment of the present invention;

FIG. 19 is a diagram illustrating an example of commercial goods arrangement information according to an embodiment of the present invention;

FIG. 20 is a flowchart illustrating an example of the service use processing of the information processing system according to an embodiment of the present invention;

FIG. 21 is a flowchart of an example of virtual space display processing according to an embodiment of the present invention;

FIG. 22 is an image diagram of an example of an image of a virtual store displayed on a user terminal according to an embodiment of the present invention; and

FIG. 23 is an image diagram of an example of an image of a virtual store displayed on a user terminal according to an embodiment of the present invention.

### DESCRIPTION OF THE EMBODIMENTS

Each embodiment of the present invention will now be described with reference to the accompanying drawings.

### First Embodiment

The first embodiment is an example in which the commercial goods to be sold are apparel commercial goods.

### <System Configuration>

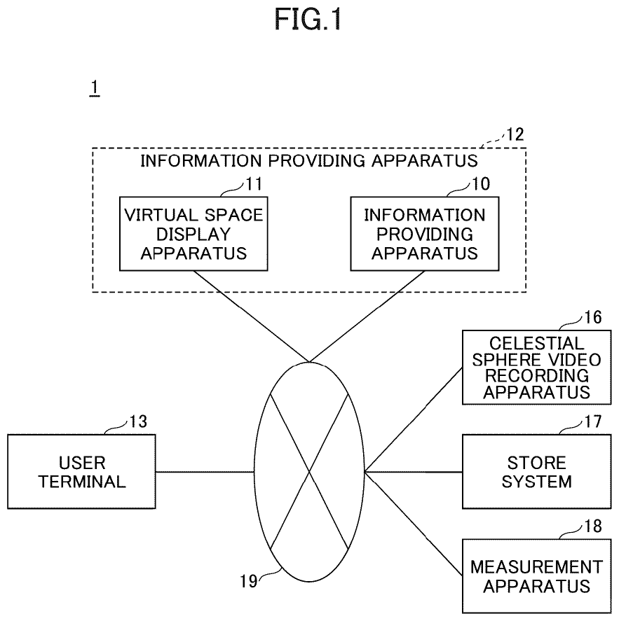

FIG. 1 is a configuration diagram of an example of an information processing system according to the present embodiment. An information processing system 1 illustrated in FIG. 1 includes an information providing apparatus 10, a virtual space display apparatus 11, a user terminal 13, a celestial sphere video recording apparatus 16, a store system 17, and a measurement apparatus 18, and performs communication via a network 19. The network 19 is the Internet, a Local Area Network (LAN), or the like. An information providing apparatus 12 illustrated by the dotted line in FIG. 1 is an example of an apparatus that combines the functions of the information providing apparatus 10 and the virtual space display apparatus 11.

The user terminal 13 is an information processing terminal operated by a user using the virtual space as described later. The user terminal 13 is a Personal Computer (PC), a cellular phone, a smartphone, a tablet terminal, a game machine, or a Personal Digital Assistant (PDA), etc.

The virtual space display apparatus 11 executes processing related to the display of the virtual space. The virtual space display apparatus 11 displays a virtual store and a real store described later on the user terminal 13. In the present embodiment, a virtual store is a store existing in a virtual space generated by the computer graphics (CG) technology. The user can operate the user terminal 13 and view commercial goods in the virtual store while moving in the virtual store with an avatar, for example.

Further, in the present embodiment, a real store is a store existing in a real space. The user can operate the user terminal 13 and observe the real store by a video (live video) captured inside the real store. Image capturing inside the real store can be performed by the celestial sphere video recording apparatus 16 described later, a wearable camera mounted to a salesperson of a store existing in the real space, or a built-in camera of an information processing terminal operated by the salesperson, etc.

The wearable camera is mounted on the head or shoulder of the salesperson, and an image (eye view image) is captured in a hands-free manner in the direction in which the salesperson is looking. For example, the user can confirm the actual texture of the commercial goods by looking at the video captured inside the real store.

The celestial sphere video recording apparatus 16 is installed at the sales floor or the like where the commercial goods is sold inside the store existing in the real space. The celestial sphere video recording apparatus 16 can capture a 360 degree image of the surroundings and distribute a live video of the sales floor or the like where the commercial goods is sold in the store existing in the real space. The celestial sphere video recording apparatus 16 can use a digital camera or the like to obtain a 360 degree celestial sphere panoramic image in a single shot. The celestial sphere video recording apparatus 16 is an example, and may be an image capturing apparatus capable of, for example, performing a panning operation to sway the image capturing direction in the left and right directions and a tilting operation to sway the image capturing direction in the vertical direction according to the user terminal 13. Further, the celestial sphere video recording apparatus 16 may be formed of, for example, a plurality of image capturing apparatuses, and may have a configuration capable of distributing a video captured in a store obtained by continuously connecting videos captured by using each of the apparatuses.

The store system 17 is a store system of a store that sells commercial goods by using the information processing system 1 according to the present embodiment. The measurement apparatus 18 is an apparatus that scans the body shape of a user. The measurement apparatus 18 measures the body shape which is an example of the attribute information of the user. The measurement apparatus 18 may be implemented in a configuration of receiving the measured information from an image obtained by capturing the user by an application installed (downloaded) in the user terminal 13. The information processing system 1 according to the present embodiment may have an apparatus for inputting the attribute information of the user, in place of the measurement apparatus 18 or together with the measurement apparatus 18, in accordance with the type of the attribute information of the user required for selecting commercial goods. Further, in the case of a virtual store or a real store of a household appliance mass retailer or a large furniture store in another embodiment described later, measurement information of a target in a captured image can be acquired from the image captured by the user by using any technique such as the principle of triangulation or a 3600 celestial sphere panoramic image, etc. In this case, the measurement information is the size (for example, the vertical length and the horizontal length of furniture, home appliances, etc.) of the target (that is, the place where the commercial goods are installed) in the captured image, and it is possible to efficiently advance a business meeting or the purchase of commercial goods according to the living space, etc., of the user.

The information providing apparatus 10 acquires the following behavior history information of the user in the virtual store and the real store. The information providing apparatus 10 determines the proposal information to be proposed to the user who displays the virtual store or the real store on the user terminal 13, based on the attribute information and the behavior history information of the user, as described later. The proposal information determined by the information providing apparatus 10 is displayed on the user terminal 13 operated by the user.

The information providing apparatus 10 and the virtual space display apparatus 11 are PCs or workstations, etc. The information providing apparatus 10 and the virtual space display apparatus 11 may be implemented by a server apparatus, an Application Service Provider (ASP), or cloud computing.

The virtual space display apparatus 11 may perform processing relating to a Web site where a store sells commercial goods, such as a payment function for commercial goods. The payment function for commercial goods may be provided by the store system 17.

In this way, according to the information processing system 1 according to the present embodiment, the behavior history information of the user in the virtual store or the real store that has been displayed on the user terminal 13, can be passed over to the virtual store or the real store to be displayed from next time and used to determine the proposed commercial goods (recommended commercial goods) from among the commercial goods sold in the virtual store or the real store.

The configuration of the information processing system 1 illustrated in FIG. 1 is an example. For example, at least a part of the functions of the information providing apparatus 10 may be provided in the virtual space display apparatus 11. At least a part of the functions of the virtual space display apparatus 11 may be provided in the information providing apparatus 10. Furthermore, a part of the information providing apparatus 10 and the virtual space display apparatus 11 may be provided in the user terminal 13.

### <Hardware Configuration>

### <<Computer>>

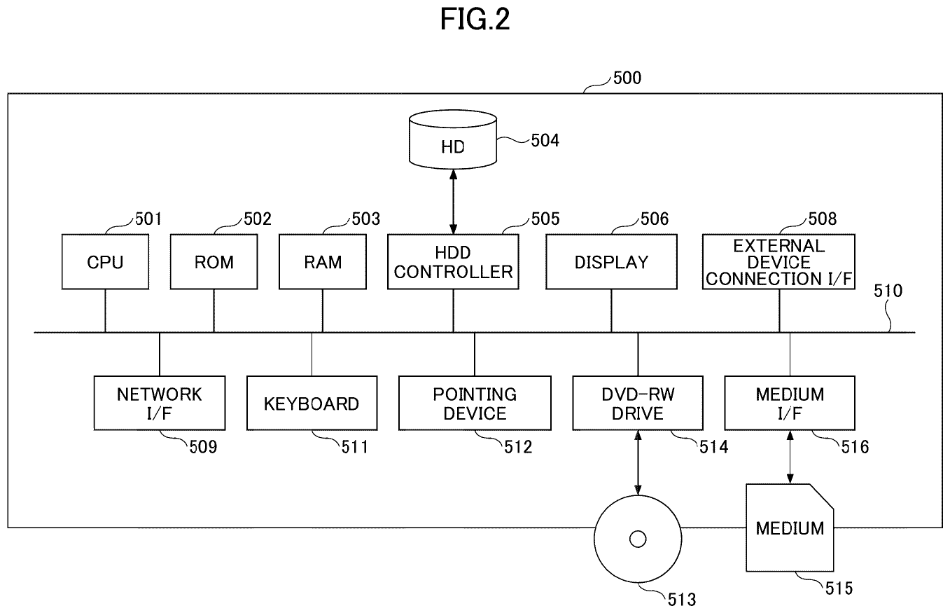

The information providing apparatus 10 and the virtual space display apparatus 11 illustrated in FIG. 1 are implemented, for example, by a computer 500 having the hardware configuration illustrated in FIG. 2. When the user terminal 13 illustrated in FIG. 1 is a PC, the user terminal 13 is implemented, for example, by the computer 500 having the hardware configuration illustrated in FIG. 2. FIG. 2 is a hardware configuration diagram of an example of a computer according to the present embodiment.

The computer 500 includes a Central Processing Unit (CPU) 501, a Read Only Memory (ROM) 502, a Random Access Memory (RA) 503, an Hard Disk (HD) 504, an HDD (Hard Disk Drive) controller 505, a display 506, an external device connection interface (I/F) 508, a network I/F 509, a data bus 510, a keyboard 511, a pointing device 512, a Digital Versatile Disk Rewritable (DVD-RW) drive 514, and a medium I/F 516.

Among these, the CPU 501 controls the operation of the entire computer 500 according to a program. The ROM 502 stores a program used for driving the CPU 501 such as an initial program loader (IPL). The RAM 503 is used as a work area of the CPU 501. The HD 504 stores various kinds of data such as programs. The HDD controller 505 controls the reading or writing of various kinds of data from or to the HD 504 in accordance with the control of the CPU 501.

The display 506 displays various kinds of information such as cursors, menus, windows, characters, or images. The external device connection I/F 508 is an interface for connecting various external devices. The external device in this case is, for example, a Universal Serial Bus (USB) memory, etc. The network I/F 509 is an interface for data communication by using the network 19. The data bus 510 is an address bus or a data bus for electrically connecting each element such as the CPU 501.

The keyboard 511 is a type of input means provided with a plurality of keys for inputting characters, numbers, various instructions, etc. The pointing device 512 is a type of input means for selecting and executing various instructions, selecting a processing target, moving a cursor, etc. The DVD-RW drive 514 controls the reading or writing of various kinds of data from or to a Digital Versatile Disc Rewritable (DVD-RW) 513 as an example of a removable recording medium. The recording medium is not limited to the DVD-RW, but may be a Digital Versatile Disc Recordable (DVD-R) or the like. The medium I/F 516 controls the reading or writing (storage) of data from or to a recording medium 515 such as the flash memory.

The hardware configuration illustrated in FIG. 2 is an example, and does not need to include all of the elements illustrated in FIG. 2, or may include elements other than those illustrated in FIG. 2.

### «Smartphone»

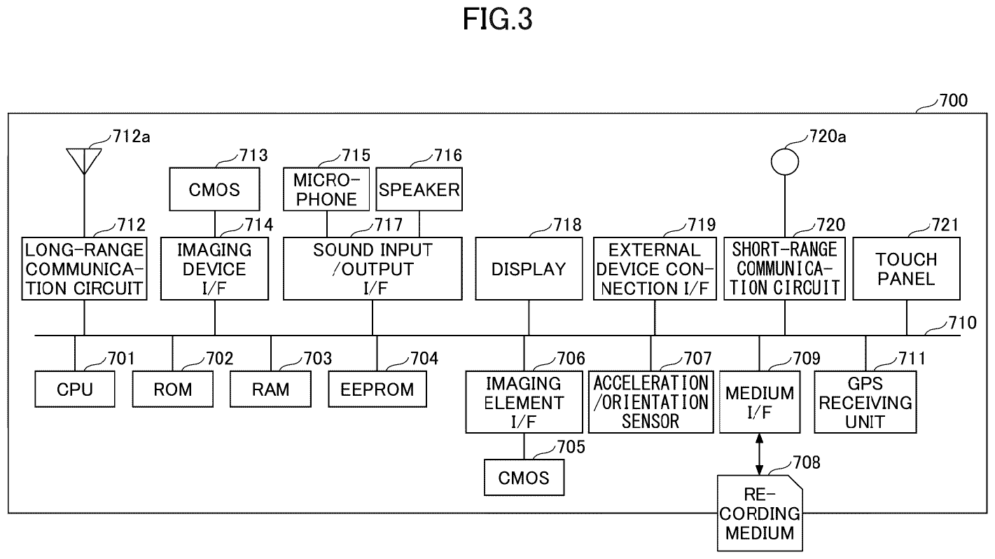

The user terminal 13 is implemented by, for example, a smartphone 700 having the hardware configuration illustrated in FIG. 3. Here, an example in which the user terminal 13 is the smartphone 700 will be described. FIG. 3 is a hardware configuration diagram of an example of a smartphone according to the present embodiment. As illustrated in FIG. 3, the smartphone 700 includes a CPU 701, a ROM 702, a RAM 703, an Electrically Erasable Programmable Read-Only Memory (EEPROM) 704, a Complementary Metal-Oxide-Semiconductor (CMOS) sensor 705, an imaging device I/F 706, an acceleration/orientation sensor 707, a medium I/F 709, and a global positioning system (GPS) receiving unit 711.

The CPU 701 controls the operation of the entire smartphone 700. The ROM 702 stores programs used to drive the CPU 701 such as the CPU 701 and the IPL, etc. The RAM 703 is used as a work area of the CPU 701. The EEPROM 704 reads or writes various kinds of data such as a program for the smartphone 700 in accordance with the control of the CPU 701.

The CMOS sensor 705 is a kind of built-in imaging means for obtaining image data by capturing a subject (mainly a self-image) in accordance with the control of the CPU 701. The imaging means may not be the CMOS sensor 705, but may be an imaging means such as a charge-coupled device (CCD) sensor. The imaging device I/F 706 is a circuit for controlling the drive of the CMOS sensor 705. The acceleration/orientation sensor 707 is a variety of sensors such as an electronic magnetic compass, a gyrocompass, and an acceleration sensor for detecting the geomagnetic field.

The medium I/F 709 controls the reading or writing (storage) of data from or to a recording medium 708 such as a flash memory. The GPS receiving unit 711 receives a GPS signal from a GPS satellite.

Further, the smartphone 700 includes a long-range communication circuit 712, a CMOS sensor 713, an imaging device I/F 714, a microphone 715, a speaker 716, a sound input/output I/F 717, a display 718, an external device connection I/F 719, a short-range communication circuit 720, an antenna 720a of the short-range communication circuit 720, and a touch panel 721.

The long-range communication circuit 712 communicates with other devices via the network 19. The CMOS sensor 713 is a kind of built-in imaging means for capturing a subject and obtaining image data under the control of the CPU 701. The imaging device I/F 714 is a circuit for controlling the drive of the CMOS sensor 713. The microphone 715 is a built-in circuit that converts sound into an electrical signal. The speaker 716 is a built-in circuit that converts an electrical signal into a physical vibration to produce sound, such as music or voice sound.

The sound input/output I/F 717 is a circuit that processes the input/output of sound signals between the microphone 715 and the speaker 716 under the control of the CPU 701. The display 718 is a type of display unit such as a liquid crystal or an organic Electro Luminescence (EL) that displays an image of a subject and various icons. The display may be a head-mounted display (HMD). The external device connection I/F 719 is an interface for connecting various external devices. The short-range communication circuit 720 is a communication circuit such as Near Field Communication (NFC) and Bluetooth. The touch panel 721 is a type of input unit in which a user presses the display 718 to operate the smartphone 700.

The smartphone 700 also includes a bus line 710. The bus line 710 is an address bus, a data bus or the like for electrically connecting each element such as the CPU 701 illustrated in FIG. 3.

### <Functional Configuration>

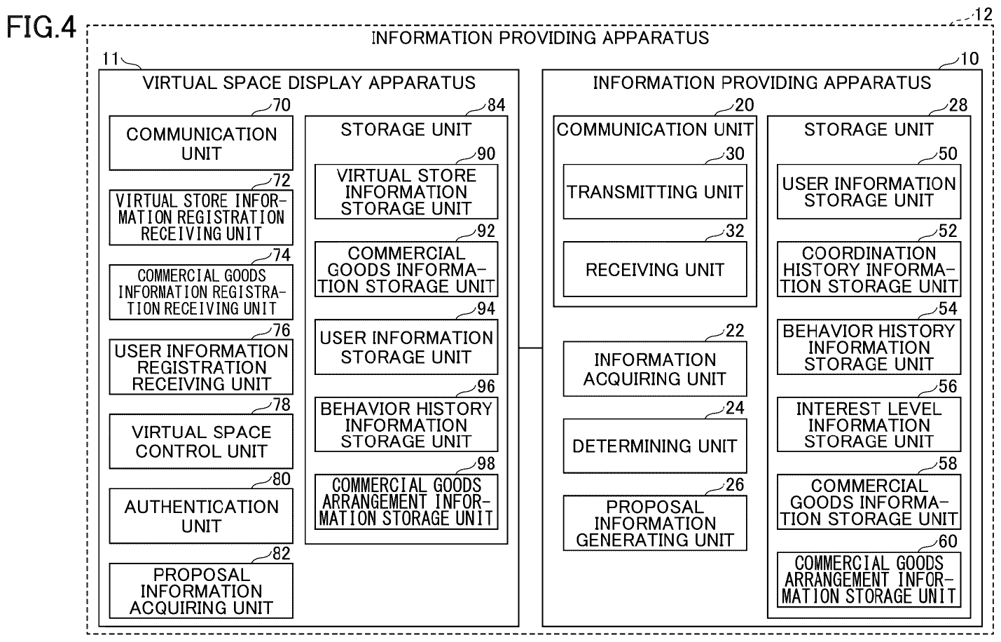

The information providing apparatus 10 and the virtual space display apparatus 11 of the information processing system 1 according to the present embodiment are implemented by the functional configuration illustrated in FIG. 4, for example. FIG. 4 is a functional configuration diagram of an example of the information providing apparatus and the virtual space display apparatus according to the present embodiment. In the functional configuration diagram of FIG. 4, configurations unnecessary for the description of the present embodiment are omitted as appropriate. The information providing apparatus 10 and the virtual space display apparatus 11 implement, for example, the functional configuration of FIG. 4 by executing programs such as an OS and an application.

The virtual space display apparatus 11 of FIG. 4 includes a communication unit 70, a virtual store information registration receiving unit 72, a commercial goods information registration receiving unit 74, a user information registration receiving unit 76, a virtual space control unit 78, an authentication unit 80, a proposal information acquiring unit 82, and a storage unit 84. The storage unit 84 includes a virtual store information storage unit 90, a commercial goods information storage unit 92, a user information storage unit 94, and a behavior history information storage unit 96.

The communication unit 70 communicates with the information providing apparatus 10, the user terminal 13, the celestial sphere video recording apparatus 16, the store system 17, and the measurement apparatus 18. The virtual store information registration receiving unit 72 receives registration of virtual store information necessary for displaying the virtual store and the real store on the user terminal 13, and stores the virtual store information in the virtual store information storage unit 90 of the storage unit 84. The virtual store information storage unit 90 stores virtual store information.

The commercial goods information registration receiving unit 74 receives the registration of commercial goods information of the commercial goods sold in the virtual store and the real store, and stores the commercial goods information in the commercial goods information storage unit 92 of the storage unit 84. The commercial goods information storage unit 92 stores the commercial goods information. The user information registration receiving unit 76 receives the registration of the user information of the user who uses the virtual store and the real store, and stores the user information in the user information storage unit 94 of the storage unit 84. The user information storage unit 94 stores the user information.

The virtual space control unit 78 displays the virtual store and the real store on the user terminal 13 in accordance with the user's operation on the user terminal 13. Further, the virtual space control unit 78 stores the user's behavior in the virtual store or the real store displayed on the user terminal 13 as behavior history information in the behavior history information storage unit 96 of the storage unit 84. The behavior history information storage unit 96 stores behavior history information. The authentication unit 80 authenticates the user who operates the user terminal 13. The proposal information acquiring unit 82 provides commercial goods information, user information, and behavior history information stored in the storage unit 84 to the information providing apparatus 10, and acquires proposal information such as the proposed commercial goods from the information providing apparatus 10.

The virtual space control unit 78 displays proposal information, based on the behavior history information of the user in the virtual store and the real store displayed on the user terminal 13 so far, on the user terminal 13 displaying the virtual store and the real store.

The information providing apparatus 10 illustrated in FIG. 4 includes a communication unit 20, an information acquiring unit 22, a determining unit 24, a proposal information generating unit 26, and a storage unit 28. The communication unit 20 includes a transmitting unit 30 and a receiving unit 32. The storage unit 28 includes a user information storage unit 50, a coordination history information storage unit 52, a behavior history information storage unit 54, an interest level information storage unit 56, and a commercial goods information storage unit 58.

The communication unit 20 communicates with the virtual space display apparatus 11. The transmitting unit 30 of the communication unit 20 transmits various kinds of information to the virtual space display apparatus 11. The receiving unit 32 receives various kinds of information from the virtual space display apparatus 11.

The information acquiring unit 22 acquires commercial goods information, user information, and behavior history information from the virtual space display apparatus 11. Based on the user information and the behavior history information, the determining unit 24 determines the preference of the user as described later. The determining unit 24 determines the proposal information such as the proposed commercial goods to be proposed to the user by using the preference of the user. The proposal information generating unit 26 generates proposal information such as a proposal commercial goods to be transmitted to the virtual space display apparatus 11.

The user information storage unit 50 of the storage unit 28 stores user information acquired from the virtual space display apparatus 11. The coordination history information storage unit 52 stores coordination history information of a user acquired from the virtual space display apparatus 11. Coordination history information is history information of coordination performed by the user in the virtual space. The behavior history information storage unit 54 stores behavior history information acquired from the virtual space display apparatus 11.

The interest level information storage unit 56 stores interest level information used to determine the preference of the user and proposal information from the behavior history information of the user. The interest level information is used to apply a score to each piece of behavior history, for example. The commercial goods information storage unit 58 stores commercial goods information acquired from the virtual space display apparatus 11.

The functional configuration of FIG. 4 is an example, and some of the functions of the information providing apparatus 10 may be provided in the virtual space display apparatus 11, or some of the functions of the virtual space display apparatus 11 may be provided in the information providing apparatus 10. Further, the information providing apparatus 12 may be formed by integrating the functions of the information providing apparatus 10 and the functions of the virtual space display apparatus 11. Furthermore, the division of the information providing apparatus 10 and the virtual space display apparatus 11 illustrated in FIG. 4 is an example, and the corresponding functions may be implemented by being divided into three or more apparatuses.

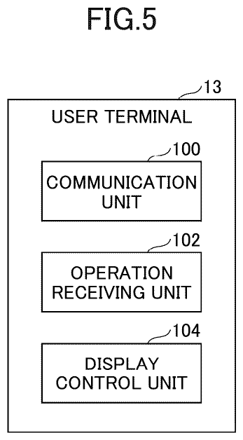

The user terminal 13 of the information processing system 1 according to the present embodiment is implemented by a functional configuration illustrated in FIG. 5, for example. FIG. is a functional configuration diagram of an example of a user terminal according to the present embodiment. In the functional configuration diagram of FIG. 5, configurations unnecessary for the description of the present embodiment are omitted as appropriate. The user terminal 13 implements, for example, the functional configuration of FIG. 5 by executing programs such as an OS and an application.

The user terminal 13 of FIG. 5 includes a communication unit 100, an operation receiving unit 102, and a display control unit 104. The communication unit 100 communicates with the virtual space display apparatus 11 and the store system 17. The operation receiving unit 102 receives an operation from the user. Based on various kinds of data received from the virtual space display apparatus 11, the display control unit 104 displays videos of the virtual store and the real store on the display 506 or 718. The functional configuration of FIG. 5 is an example.

### <Data Configuration>

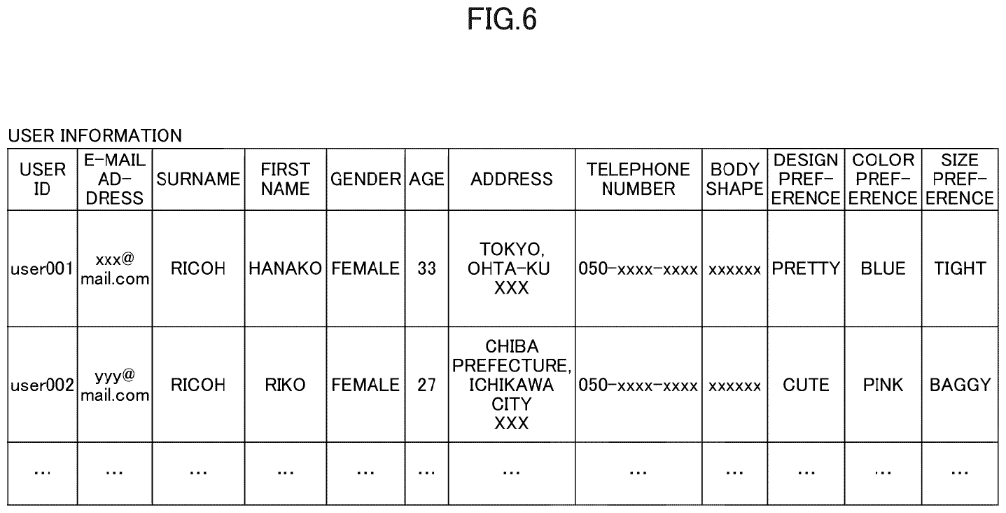

FIG. 6 is a configuration diagram of an example of user information. The user information illustrated in FIG. 6 includes user ID (user identification information), e-mail address, surname, first name, gender, age, address, telephone number, body shape, design preference, color preference, and size preference as items. The items of design preference, color preference, and size preference are examples of user preferences. The items of gender, age, body shape, design preference, color preference, and size preference are examples of user attribute information. The item of body shape may be, for example, data representing the user's body shape measured by the measurement apparatus 18, or data representing the body shape input by the user.

The items of design preference, color preference, and size preference in the user information illustrated in FIG. 6 may be initially set by the user and later updated according to the user's preference as a result of the determination by the determining unit 24.

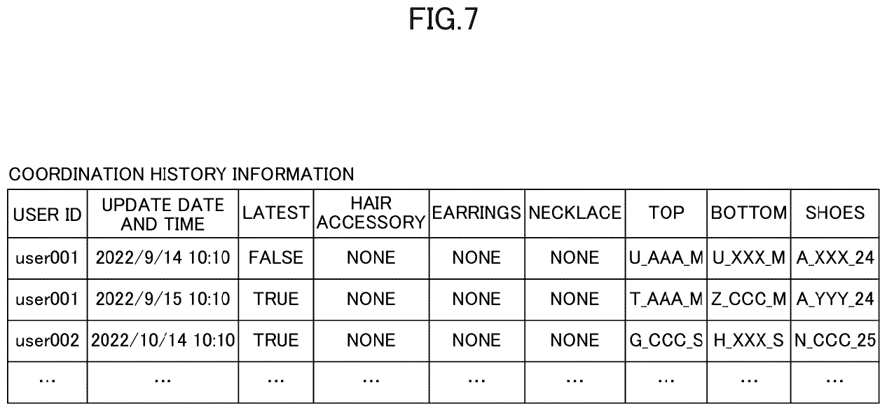

FIG. 7 is a configuration diagram illustrating an example of coordination history information. The coordination history information of FIG. 7 includes user ID, update date and time, latest, hair accessory, earrings, necklace, top, bottom, and shoes as items. The update date and time item is set with date and time information indicating the date and time when coordination was performed by the user in the virtual space. The latest item indicates whether the coordination is the latest coordination, and “TRUE” is set when the coordination is the latest, and “FALSE” is set when the coordination is not the latest.

Items of hair accessories, earrings, necklace, top, bottom, and shoes are information recording the coordination performed by the user in the virtual space, and a commercial goods ID (identification information) of the commercial goods is set. For example, in coordination history information, the coordination which the user has tried on by an avatar in the virtual store is set.

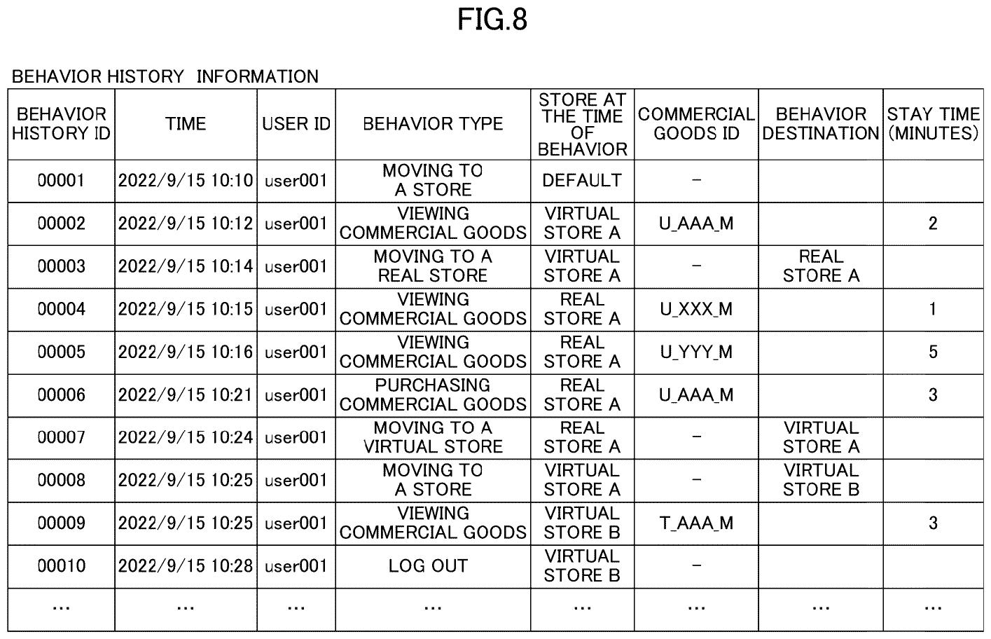

FIG. 8 is a configuration diagram of an example of behavior history information. The behavior history information of FIG. 8 includes behavior history ID (identification information), time, user ID, behavior type, store at the time of behavior, commercial goods ID, behavior destination, and stay time (minutes) as items. For the time item, date and time information of the behavior performed by the user is set. For the behavior type item, information representing the type of the behavior is set such as moving to a store, viewing commercial goods, moving to a real store, purchasing commercial goods, and moving to a virtual store. For example, the behavior type “moving to a real store” is a behavior to switch a video displayed on the user terminal 13 from a virtual store to a real store. The behavior type “moving to a virtual store” is a behavior to switch a video displayed on the user terminal 13 from a real store to a virtual store.

“Viewing commercial goods” as a behavior type is a behavior in which a user views commercial goods at a virtual store or a real store. “Purchasing commercial goods” as a behavior type is a behavior in which a user purchases commercial goods at a virtual store or a real store. The item of store at the time of behavior is the identification information of the virtual store or the real store where the behavior was performed.

When the behavior type is “viewing commercial goods” or “purchasing commercial goods”, the item of the commercial goods ID is set to the identification information of the commercial goods that the user viewed or purchased at the virtual store or the real store. When the behavior type is “moving store”, “moving to a real store”, or “moving to a virtual store”, the behavior destination item is set to the identification information of the virtual store or the real store to which the user moved. The item of stay time (minutes) is the time during which the user filmed the real store or the virtual store with the user terminal 13 (the time during which the user stayed at the real store or the virtual store via the user terminal 13).

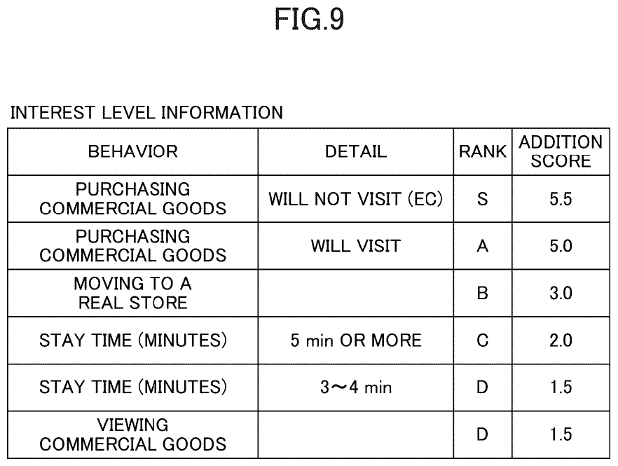

FIG. 9 is a configuration diagram of an example of interest level information. The interest level information of FIG. 9 includes behavior, detail, rank, and addition score as items. For the behavior item, the behavior type or the stay time (minutes) item in the behavior history information illustrated in FIG. 8 is set. The detail item is an example of information to supplement the behavior item. For the rank item, the importance of the user's behavior is set to turn the user's interest level into a score. For the addition score item, the score to be added to the user's behavior is set to turn the user's interest level into a score. Note that in this example, the user's interest level is turned into a score by using at least one of the rank item (FIG. 9 illustrates an example in which the importance of the user's behavior is ranked from S to D in descending order) or the addition score item (FIG. 9 illustrates an example in which the addition score is set in order of importance of the user's behavior), but the present embodiment is not limited to this (for example, the interest level may be ranked as high, medium, low, etc.).

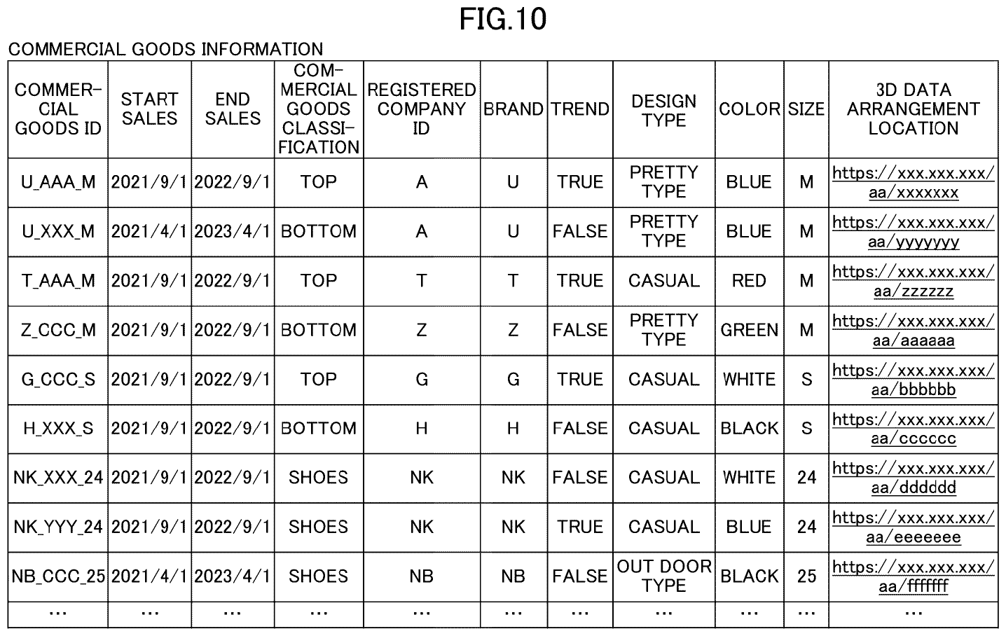

FIG. 10 is a configuration diagram of an example of commercial goods information. The commercial goods information of FIG. 10 includes commercial goods ID, start sales, end sales, commercial goods classification, registered company ID (identification information), brand, trend, design type, color, size, and 3D data arrangement location as items. The trend item indicates whether the commercial goods is in trend or not, and “TRUE” is set when the commercial goods is in trend, and “FALSE” is set when the commercial goods is not the latest.

The items of design type, color, and size are examples of information used to determine user preferences. Therefore, the items used to determine user preferences vary by commercial goods. The items of design type, color, and size in FIG. 10 are examples. The item of design type is information for classifying the design of commercial goods, and pretty type, casual type, and outdoor type are set. The item of color is set to indicate the color of the commercial goods. The item of size is set to indicate the size of the commercial goods. The item of the 3D data arrangement location is set to indicate the location where the 3D data used for displaying the commercial goods in the virtual space is arranged.

### <Processing>

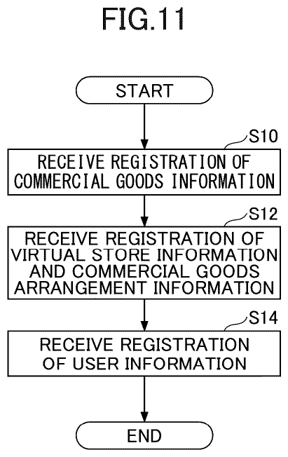

The processing procedure of the information processing system 1 according to the present embodiment will be described below. FIG. 11 is a flowchart illustrating an example of the registration process of the information processing system according to the present embodiment. The order of the processes in the flowchart of FIG. 11 is an example, and the order of the processes may be changed.

In step S10, the commercial goods information registration receiving unit 74 of the virtual space display apparatus 11 receives the registration of the commercial goods information of the commercial goods sold in the virtual store and the real store, and stores the commercial goods information of FIG. 10, for example, in the commercial goods information storage unit 92 of the storage unit 84.

In step S12, the virtual store information registration receiving unit 72 of the virtual space display apparatus 11 receives the registration of the virtual store information necessary for displaying the virtual store and the real store on the user terminal 13, and stores the virtual store information in the virtual store information storage unit 90 of the storage unit 84. The virtual store information includes various kinds of data such as 3D data necessary for displaying the virtual store on the user terminal 13, and various kinds of data such as the Uniform Resource Locator (URL) of the access destination of the celestial sphere video recording apparatus 16 of the real store necessary for displaying the real store on the user terminal 13.

In step S14, the user information registration receiving unit 76 of the virtual space display apparatus 11 receives the registration of user information of the user using the virtual store and the real store, and stores the user information illustrated in FIG. 6, for example, in the user information storage unit 94 of the storage unit 84. In step S14, the user information registration receiving unit 76 may receive data indicating the body shape of the user measured by the measurement apparatus 18, for example.

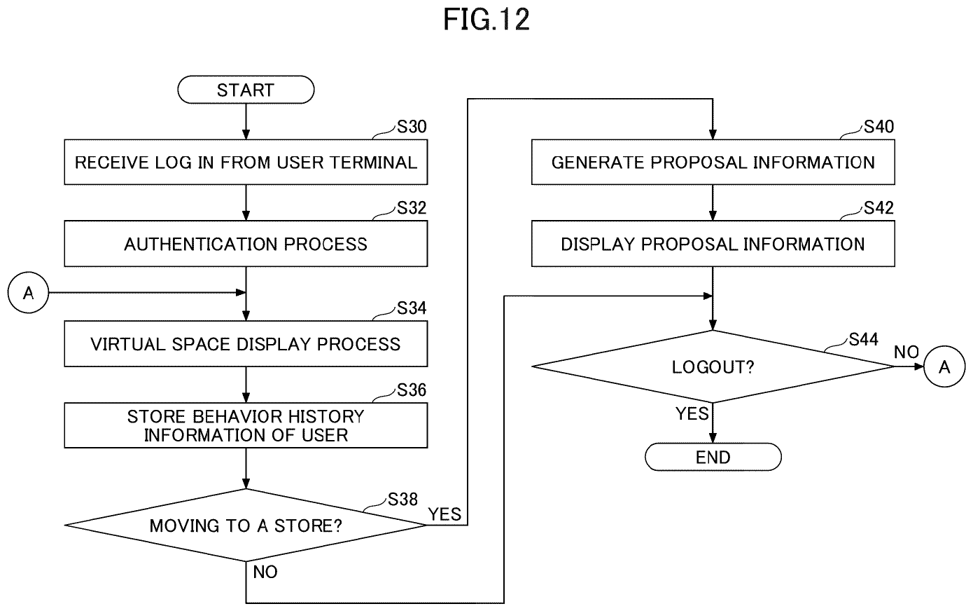

The user who operates the user terminal 13 uses the service provided by the information processing system 1 according to the present embodiment by the procedure illustrated in FIG. 12, for example. FIG. 12 is a flowchart illustrating an example of the service use processing of the information processing system according to the present embodiment.

In step S30, the authentication unit 80 of the virtual space display apparatus 11 receives a login operation from the user terminal 13. In step S32, the authentication unit 80 authenticates the user who operates the user terminal 13. When the authentication is not successful, the virtual space display apparatus 11 does not perform the processing after step S34. When the authentication is successful, the virtual space display apparatus 11 performs the processing after step S34.

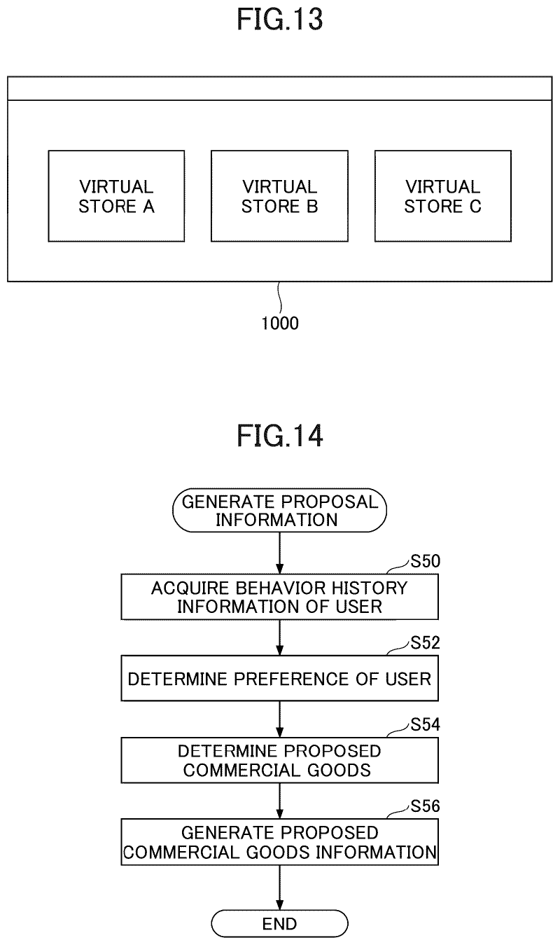

In step S34, the virtual space control unit 78 of the virtual space display apparatus 11 uses the virtual store information stored in the virtual store information storage unit 90 of the storage unit 84 to display the virtual store on the user terminal 13 operated by the user. For example, the virtual space control unit 78 may automatically display a default virtual store when a default virtual store is set. For example, when a default virtual store is not set, the virtual space control unit 78 may have the virtual store to be displayed after login selected from, for example, a store selection screen 1000 illustrated in FIG. 13. FIG. 13 is an image diagram of an example of the store selection screen.

The virtual space control unit 78 displays the virtual store and the real store on the user terminal 13 in accordance with the user's operation on the user terminal 13. The user operates the user terminal 13 and performs behaviors such as moving to a store, viewing commercial goods, moving to a real store, purchasing commercial goods, and moving to a virtual store in the displayed virtual space.

In step S36, the virtual space control unit 78 stores the user's behavior in the virtual store or real store displayed on the user terminal 13 in the behavior history information storage unit 96, for example, as the behavior history information illustrated in FIG. 8. Accordingly, the behavior history information illustrated in FIG. 8 stores the user's behavior history in the virtual store or real store displayed on the user terminal 13.

In step S38, the virtual space control unit 78 determines whether the behavior of the user in the virtual store or the real store displayed on the user terminal 13 indicates moving to a store. For example, in the behavior history information illustrated in FIG. 8, when the behavior type is “moving to a store”, “moving to a real store”, or “moving to a virtual store”, the virtual space control unit 78 determines that the behavior is moving to a store.

The virtual store or real store displayed on the user terminal 13 before the moving to a store is an example of the first virtual space. The virtual store or real store displayed on the user terminal 13 after the moving to a store is an example of the second virtual space.

In step S38, when the virtual space control unit 78 determines that the behavior of the user in the virtual store or real store displayed on the user terminal 13 is not moving to a store, the process proceeds to step S44. When the virtual space control unit 78 determines that the behavior of the user in the virtual store or real store displayed on the user terminal 13 is moving to a store, the process proceeds to step S40. In step S40, the proposal information acquiring unit 82 provides commercial goods information, user information, and behavior history information stored in the storage unit 84 to the information providing apparatus 10, and requests proposal information (for example, a proposed commercial goods) to the user who operates the user terminal 13. The receiving unit 32 of the information providing apparatus 10 receives commercial goods information, user information, and behavior history information from the virtual space display apparatus 11, and receives a request for proposal information from the virtual space display apparatus 11.

The information providing apparatus 10, which has received a request for proposal information from the virtual space display apparatus 11, generates proposal information for the user who operates the user terminal 13, by the procedure illustrated in FIG. 14, for example.

FIG. 14 is a flowchart illustrating an example of the process for generating proposal information to the user. In step S50, the information acquiring unit 22 of the information providing apparatus 10 acquires commercial goods information, user information, and behavior history information received from the virtual space display apparatus 11.

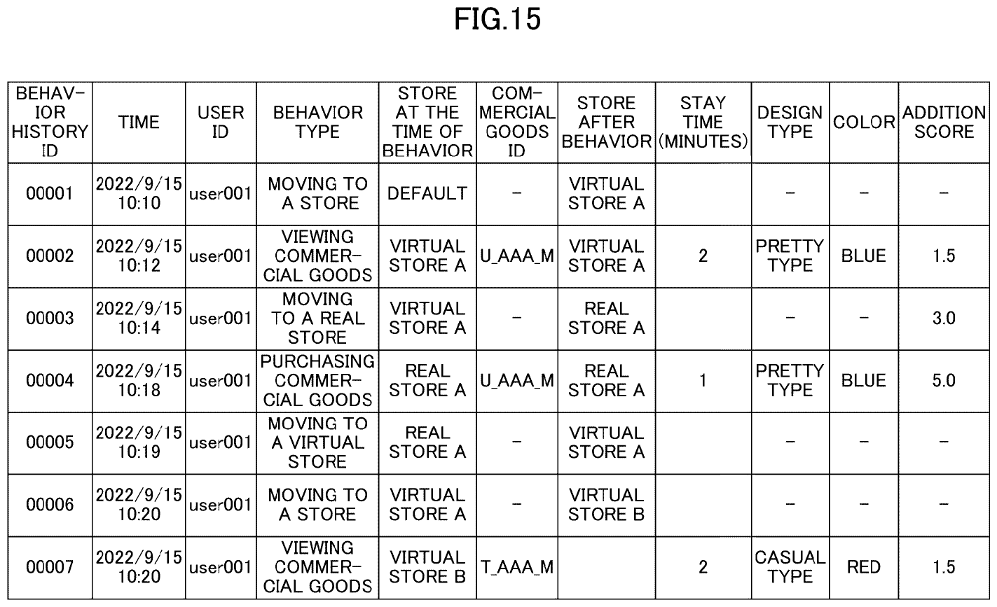

In step S52, the determining unit 24 of the information providing apparatus 10 determines the preference of the user who operates the user terminal 13 as follows. The determining unit 24 uses the information illustrated in FIG. 15 in which the items of the design type and color of the commercial goods information and the item of the addition score of the interest level information are associated with the items of the behavior history information.

FIG. 15 is a configuration diagram of an example of the information used for determining the user's preference. The items of the design type and color of the information illustrated in FIG. 15 are the design type and color of the commercial goods that the user has viewed or purchased, read from the commercial goods information illustrated in FIG. 10 based on the item of the commercial goods ID of the behavior history information. For example, in the behavior history information of the behavior history ID “00002” illustrated in FIG. 15, the design type “pretty type” and the color “blue” of the commercial goods ID “U_AAA_M” are read from the commercial goods information illustrated in FIG. 10 and are associated with the behavior history information.

The item of the addition score of the information illustrated in FIG. 15 is an addition score read from the interest level information illustrated in FIG. 9 based on the item of the behavior type of the behavior history information. For example, in the behavior history information of the behavior history ID “00002” illustrated in FIG. 15, the addition score “1.5” of the behavior type “viewing commercial goods” is read from the interest level information illustrated in FIG. 9 and is associated with the behavior history information.

The determining unit 24 refers to the information set in the item of the design type of the information illustrated in FIG. 15 and calculates the addition score for each of the same design types. For example, in the case of the information illustrated in FIG. 15, the addition score for the design type “pretty type” is calculated as “1.5+5.0=6.5”. The addition score for the design type “casual type” is calculated as “1.5”. Therefore, with the information illustrated in FIG. 15, it is determined that the “pretty type” with the highest addition score is the “design preference” preferred by the user.

The determining unit 24 refers to the information set in the item of the design type of the information illustrated in FIG. 15, and calculates an addition score for each of the same colors. For example, in the information illustrated in FIG. 15, the addition score of the color “blue” is calculated as “1.5+5.0=6.5”. The addition score of the color “red” is calculated as “1.5”. Therefore, in the information illustrated in FIG. 15, it is determined that “blue” having the highest addition score is the “color preference” preferred by the user. The determined “design preference” and “color preference” of the user are used, for example, to set or update the items of design preference and color preference in the user information illustrated in FIG. 6.

Returning to step S54 of FIG. 14, the determining unit 24 determines the proposed commercial goods to be proposed to the user by using the user's preference determined in step S52. For example, the determining unit 24 uses the items of design preference and color preference in the user information of FIG. 6 to calculate a score for each commercial goods sold in a virtual store or a real store displayed on the user terminal 13 after the moving to a store.

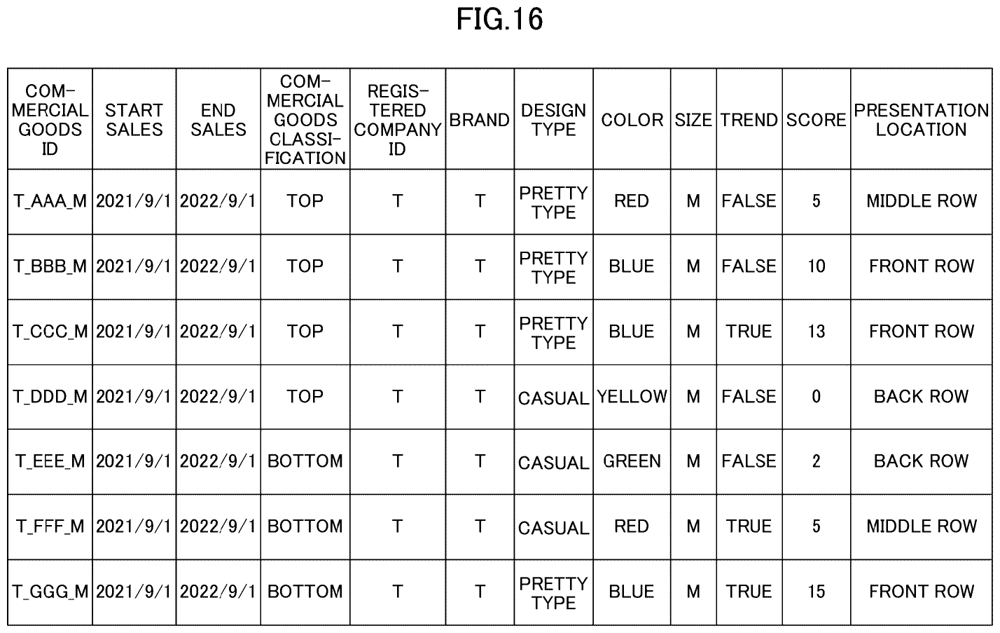

FIG. 16 is a diagram for explaining an example of a score for each commercial goods sold in a virtual store or a real store displayed on a user terminal after moving to a store. For example, in FIG. 16, a score of “+5” is given when the design type matches the design preference of the user information, a score of “+5” is given when the color matches only the color of the user information, a score of “+3” is given when the commercial goods is in trend, and a score of “+2” is given when there is no purchase of the same commercial goods classification within one month.

The determining unit 24 determines the proposed commercial goods by using the calculated score. For example, in FIG. 16, the commercial goods whose commercial goods ID is “T_GGG_M” whose score exceeds “10” and has the highest score is determined as the proposed commercial goods.

The calculation of the score for each commercial goods in step S54 may be customizable for each virtual store and each real store. For example, the calculation of the score for each commercial goods may be that a score of “+10” is given when there is commercial goods that is compatible with the purchased commercial goods within 1 month, a score of “+5” is given when the time of viewing the commercial goods is longer than 10 seconds, a score of “−5” is given when the purchase price range of the same commercial goods classification is not the same, a score of “+5” is given when the commercial goods has a large inventory, a score of “+5” is given when the commercial goods has less than or equal to one month left until the end of the sale, and a score of “+10” is given when the commercial goods is subject to a sale.

Further, the calculation of the score for each commercial goods in step S54 may be performed by purposely determining commercial goods that differs from the user's preference as a proposed commercial goods, thereby making it possible to propose a change in image. For example, in the calculation of the score for each commercial goods, the score may be set high when the commercial goods is different from the user's preference and is in trend, and the score may be set high when the commercial goods is different from the user's preference and is often purchased by other users who have the same preference. The score used in the determination of the proposed commercial goods in step S54 may be selected or set by the user so that the commercial goods expected by the user becomes the proposed commercial goods.

Returning to step S56 in FIG. 14, the proposal information generating unit 26 generates the proposed commercial goods information to be transmitted to the virtual space display apparatus 11. The transmitting unit 30 of the information providing apparatus 10 transmits the proposed commercial goods information to the virtual space display apparatus 11.

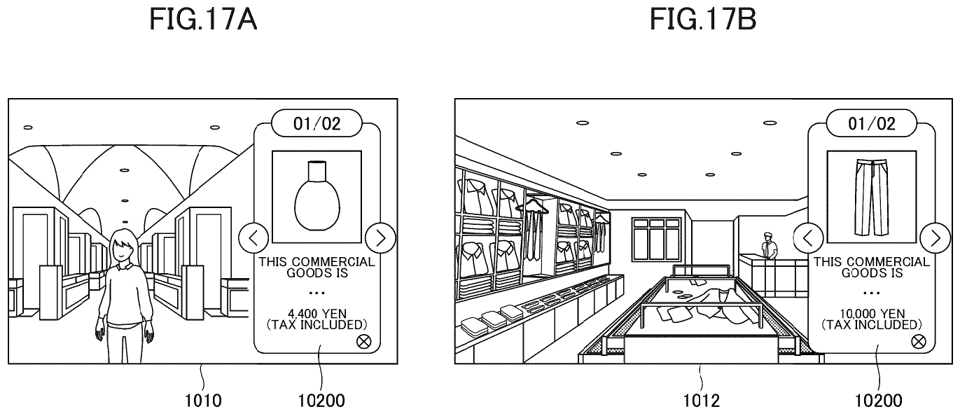

Returning to step S42 of FIG. 12, the communication unit 70 of the virtual space display apparatus 11 receives the proposed commercial goods information from the information providing apparatus 10. The proposal information acquiring unit 82 of the virtual space display apparatus 11 acquires the proposed commercial goods information received from the information providing apparatus 10. The virtual space control unit 78 of the virtual space display apparatus 11 uses the proposed commercial goods information received from the information providing apparatus 10 to display an image of a virtual store or a real store as illustrated in FIGS. 17A and 17B, for example, on the user terminal 13.

FIGS. 17A and 17B are image diagrams of an example of an image of a virtual store or a real store displayed on a user terminal. FIG. 17A is an image in which proposal information 10200 including an image of a proposed commercial goods is displayed on an image 1010 of a virtual store. FIG. 17B is an image in which the proposal information 10200 including an image of a proposed commercial goods is displayed on a live video 1012 of a real store.

The position of the proposal information 10200 is an example. The position of the proposal information 10200 may be displayed at a position to avoid the user's eye view based on the user's eye view information. In the image 1010 of the virtual store or the live video 1012 of the real store, the user may recognize the proposed commercial goods by visually changing the image of the proposed commercial goods such as color change or flashing.

The behavior history information illustrated in FIG. 8 may be stored and managed using blockchain technology. The behavior history information may be managed as a distributed ledger of the blockchain by a plurality of computers, for example. The information acquiring unit 22 of the information providing apparatus 10 can acquire behavior history information recorded by a block chain. For example, in the information processing system 1 according to the present embodiment, behavior history information may be managed as a distributed ledger of a block chain for each brand of commercial goods (or for each store).

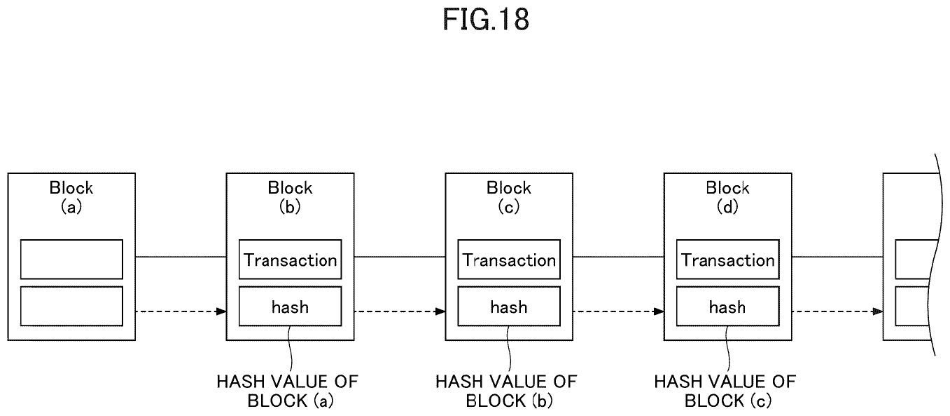

FIG. 18 is a diagram for explaining a data structure of a block chain. The behavior history information of a user is managed by a block chain in which a plurality of blocks are connected in a chain form as illustrated in FIG. 18. Each block includes transaction data which is the behavior history information of a user in a virtual store or a real store, and a hash value of the preceding block.

As illustrated in FIG. 18, in a block chain, a plurality of blocks including a hash value of the preceding block are connected in a chain shape, making it difficult to tamper with transaction data of each block. The information processing system 1 of the present embodiment can secure the legitimacy of the behavior history information by managing the behavior history information in the block chain.

For example, in the information processing system 1 of the present embodiment, the information providing apparatus 10, the virtual space display apparatus 11, and the store system 17 manage the behavior history information as a distributed ledger of the blockchain, so that the reliability of the behavior history information can be secured.

As described above, in the information processing system 1 of the present embodiment, the behavior history information of the user in the virtual space can be passed on to the user who uses the virtual space such as a virtual store and a real store while moving, and more appropriate proposal information can be provided to the user.

### Second Embodiment

A second embodiment will be described below. The different points from the first embodiment are mainly described.

### <System Configuration>

The information processing system 1 according to the second embodiment has a configuration as illustrated in FIG. 1, for example. Only the difference from the first embodiment is described.

The information providing apparatus 10 acquires the following behavior history information of the user in the virtual store and the real store. The information providing apparatus 10 determines the proposal information relating to the generation (construction) of the virtual store displayed on the user terminal 13, based on the attribute information and the behavior history information of the user.

The proposal information relating to the generation of the virtual store is, for example, information relating to the presentation of commercial goods displayed in the virtual store, and information for a presentation display according to the user's preference, etc. The proposal information relating to the generation of the virtual store is not limited to the presentation display of commercial goods, but may be information for selecting the atmosphere of the virtual store or the arrangement of shelves. The user terminal 13 operated by the user displays the virtual store in which the presentation of commercial goods is dynamically changed (customized) according to the proposal information.

Thus, according to the information processing system 1 according to the present embodiment, the behavior history information so far of a user in a virtual store or a real store displayed on the user terminal 13 can be passed over to a virtual store to be displayed next time and can be used to change the presentation display of commercial goods sold in the virtual store to suit the user.

### <Functional Configuration>

The information providing apparatus 10 and the virtual space display apparatus 11 of the information processing system 1 according to the present embodiment are implemented by the functional configuration illustrated in FIG. 4, for example. Only the difference from the first embodiment is described.

In addition to the functional elements of the first embodiment, in the second embodiment, the virtual space display apparatus 11 in FIG. 4 includes a commercial goods arrangement information storage unit 98.

In the second embodiment, the proposal information acquiring unit 82 provides commercial goods information, user information, behavior history information, and commercial goods arrangement information stored in the storage unit 84 to the information providing apparatus 10, and acquires, from the information providing apparatus 10, proposal information relating to the generation of a virtual store displayed on the user terminal 13.

Based on the proposal information relating to the generation of the virtual store acquired from the information providing apparatus 10, the virtual space control unit 78 causes the user terminal 13 to display, for example, a virtual store whose presentation display of commercial goods has been changed according to the user.

In addition to the elements of the first embodiment, in the second embodiment, the storage unit 28 of the information providing apparatus 10 includes a commercial goods arrangement information storage unit 60.

The information acquiring unit 22 acquires commercial goods information, user information, behavior history information, and commercial goods arrangement information from the virtual space display apparatus 11.

Based on the user information and behavior history information, the determining unit 24 determines the preference of the user as described later. By using the preference of the user, the determining unit 24 determines proposal information relating to the generation of a virtual store, such as the presentation of commercial goods suitable for the user. The proposal information generating unit 26 generates proposal information to be transmitted to the virtual space display apparatus 11.

The commercial goods arrangement information storage unit 60 stores commercial goods arrangement information acquired from the virtual space display apparatus 11.

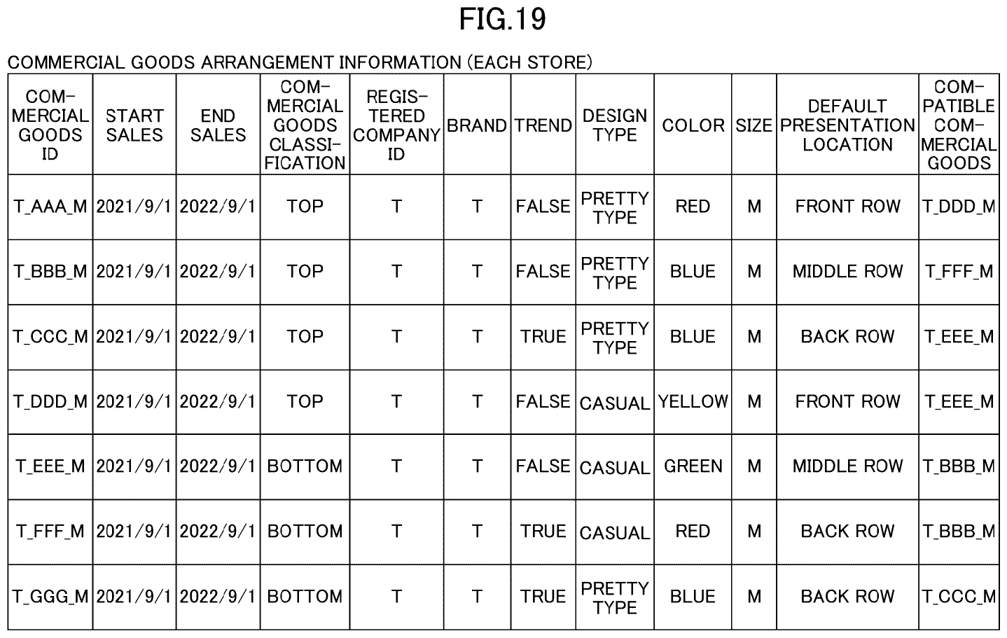

FIG. 19 is a configuration diagram of an example of the commercial goods arrangement information. The commercial goods arrangement information illustrated in FIG. 19 may be set for each store or for each brand. The commercial goods arrangement information illustrated in FIG. 19 includes commercial goods ID, start sales, end sales, commercial goods classification, registered company ID, brand, trend, design type, color, size, default presentation location, and compatible commercial goods as items.

The items of commercial goods ID, start sales, end sales, commercial goods classification, registered company ID, brand, trend, design type, color, and size are the same as those of the commercial goods information of FIG. 10. As the item of the default presentation location, the default presentation location of the commercial goods in the virtual store is set. As for the item of the compatible commercial goods, the commercial goods ID of the compatible commercial goods is set for the proposal.

### <Processing>

The processing procedure of the information processing system 1 according to the present embodiment will be described below with reference to FIG. 11. Only the difference from the first embodiment is described.

In step S12, in addition to the processing in the first embodiment, in the second embodiment, the virtual store information registration receiving unit 72 receives registration of the commercial goods arrangement information in which the default presentation location of the commercial goods in the virtual store is set, and stores the commercial goods arrangement information illustrated in FIG. 19, for example, in the commercial goods arrangement information storage unit 98 of the storage unit 84.

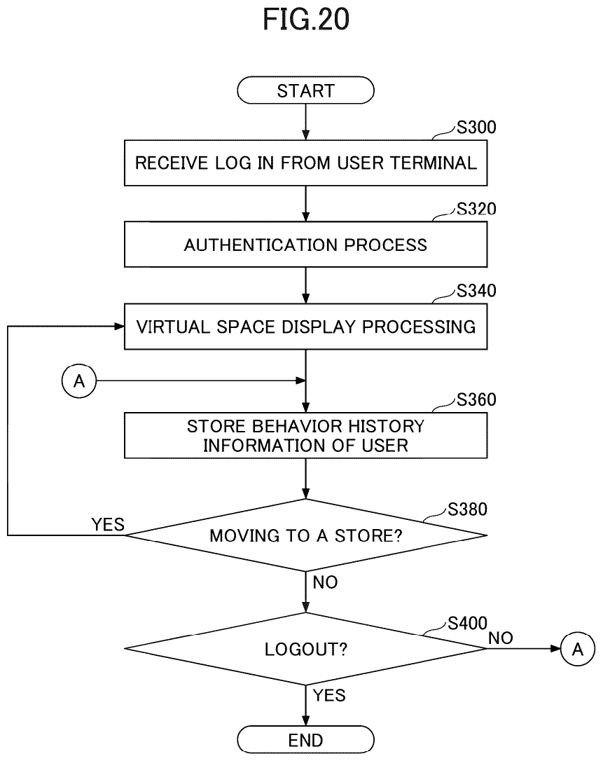

The user who operates the user terminal 13 uses the service provided by the information processing system 1 according to the present embodiment by the procedure illustrated in FIG. 20, for example. FIG. 20 is a flowchart illustrating an example of the service use processing of the information processing system according to the present embodiment.

In step S300, the authentication unit 80 of the virtual space display apparatus 11 receives a login operation from the user terminal 13. In step S320, the authentication unit 80 authenticates the user who operates the user terminal 13. When the authentication is not successful, the virtual space display apparatus 11 does not perform the processing after step S340. When the authentication is successful, the virtual space display apparatus 11 performs the processing after step S340.

In step S340, the virtual space control unit 78 of the virtual space display apparatus 11 displays the virtual store or the real store on the user terminal 13 operated by the user. For example, the virtual space control unit 78 may automatically display a default virtual store when a default virtual store is set. For example, the virtual space control unit 78 may have the virtual store to be displayed after login selected from, for example, the store selection screen 1000 illustrated in FIG. 13. Details of step S340 are described later.

The virtual space control unit 78 displays the virtual store and the real store on the user terminal 13 in accordance with the user's operation on the user terminal 13. The user operates the user terminal 13 and performs behaviors such as moving to a store, viewing commercial goods, moving to a real store, purchasing commercial goods, and moving to a virtual store in the displayed virtual store or real store.

In step S360, the virtual space control unit 78 stores the user's behavior in the virtual store or real store displayed on the user terminal 13 in the behavior history information storage unit 96, for example, as the behavior history information illustrated in FIG. 8. Accordingly, the behavior history information illustrated in FIG. 8 stores the user's behavior history in the virtual store or real store displayed on the user terminal 13.

In step S380, the virtual space control unit 78 determines whether the behavior of the user in the virtual store or the real store displayed on the user terminal 13 indicates moving to a store. For example, in the behavior history information illustrated in FIG. 8, when the behavior type is “moving to a store”, “moving to a real store”, or “moving to a virtual store”, the virtual space control unit 78 determines that the behavior is moving to a store.

The virtual store or real store displayed on the user terminal 13 before the moving to a store is an example of the first virtual space. The virtual store displayed on the user terminal 13 after the moving to a store is an example of the second virtual space.

In step S380, when the virtual space control unit 78 determines that the behavior of the user in the virtual store or real store displayed on the user terminal 13 is not moving to a virtual store, the process proceeds to step S400. When the virtual space control unit 78 determines that the behavior of the user in the virtual store or the real store displayed on the user terminal 13 is moving to a store, the process returns to step S340.

In step S400, when the virtual space control unit 78 has not received a logout operation from the user, the process returns to step S360. When the virtual space control unit 78 receives a logout operation from the user, the virtual space control unit 78 ends the processing of the flowchart illustrated in FIG. 20.

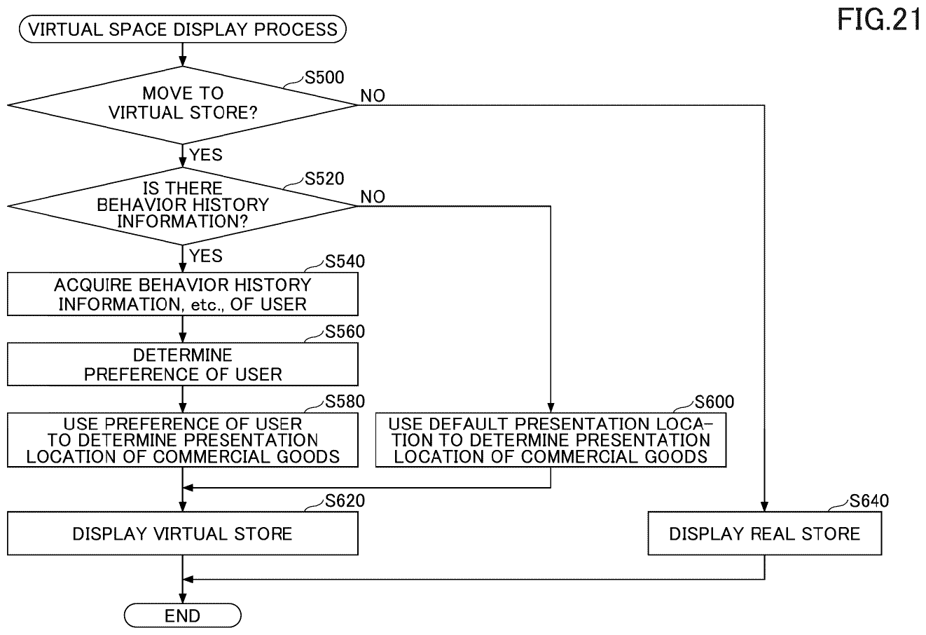

The virtual space display processing in step S340 is performed, for example, by the procedure illustrated in FIG. 21. FIG. 21 is a flowchart of an example of the virtual space display processing. The proposal information acquiring unit 82 of the virtual space display apparatus 11 requests proposal information of the presentation display of commercial goods. The receiving unit 32 of the information providing apparatus 10 receives a request for proposal information from the virtual space display apparatus 11.

The determining unit 24 of the information providing apparatus 10 that has received the request for proposal information from the virtual space display apparatus 11, determines whether the movement is to a virtual store in step S500. When the movement is not to a virtual store, the virtual space control unit 78 of the virtual space display apparatus 11 displays the real store in step S640.

When the movement is to a virtual store, the determining unit 24 of the information providing apparatus 10 determines whether there is behavior history information of the user who operates the user terminal 13 in step S520. When there is no behavior history information of the user who operates the user terminal 13, the process proceeds to step S600, and the proposal information generating unit 26 of the information providing apparatus 10 refers to, for example, the item of the default presentation location of the commercial goods arrangement information in FIG. 19, and determines the presentation location of the commercial goods by using the default presentation location. The proposal information generating unit 26 generates proposal information of the presentation display of the commercial goods by using the determined presentation location of the commercial goods. The transmitting unit 30 of the information providing apparatus 10 transmits proposal information to the virtual space display apparatus 11.

Proceeding from step S600 to step S620, the virtual space control unit 78 of the virtual space display apparatus 11, which has received proposal information from the information providing apparatus 10, displays the commercial goods that is presented and displayed according to the default presentation location, in the virtual store.

When it is determined in step S520 that there is behavior history information of the user who operates the user terminal 13, the information acquiring unit 22 of the information providing apparatus 10 acquires commercial goods information, user information, behavior history information, and commercial goods arrangement information in step S540.

In step S560, the determining unit 24 of the information providing apparatus 10 determines the preference of the user who operates the user terminal 13 as follows. The determining unit 24 uses the information illustrated in FIG. 15 in which the items of the design type and color of the commercial goods information and the items of the addition score of the interest level information are associated with the items of the behavior history information.

Returning to step S580 in FIG. 21, the determining unit 24 determines the presentation location of the commercial goods by using the user's preference determined in step S560. For example, the determining unit 24 calculates a score for each commercial goods sold in the virtual store displayed on the user terminal 13 after the moving to a store, by using the items of design preference and color preference in the user information in FIG. 6.

FIG. 16 is a diagram for explaining an example of a score for each commercial goods sold in a virtual store displayed on a user terminal after moving to a store. For example, in FIG. 16, a score of “+5” is given when the design type matches the design preference in the user information, a score of “+5” is given when the color matches only the color in the user information, a score of “+3” is given when the commercial goods is in trend, and a score of “+2” is given when there is no purchase of the same commercial goods classification within one month.

By using the calculated score, the determining unit 24 determines the presentation location of the commercial goods so that the commercial goods with the higher score is arranged at the presentation location with the higher priority. For example, FIG. 16 indicates presentation locations in the front row, the middle row, or the back row as examples of presentation locations with different priorities.

For example, the front row in FIG. 16 is an example of a presentation location with the highest priority, and is an example of a presentation location that is most easily noticed by users. The middle row in FIG. 16 is an example of a presentation location having the second highest priority, and is an example of a presentation location that is second most easily noticed by users. The back row in FIG. 16 is an example of a presentation location having the third highest priority, and is an example of a presentation location that is third most easily noticed by users. For example, in FIG. 16, commercial goods are arranged at presentation locations in the front row, the middle row, or the back row, in a descending order according to the score. The priority of the presentation location is set by considering, for example, the ease of viewing the commercial goods, the layout of the virtual store, the movement line of the user in the virtual store, and the movement of the user's gaze, etc. For example, in the example in FIG. 16, the commercial goods whose score exceeds “10” are arranged at the presentation location in the front row, the commercial goods whose score is “5 to 9” are arranged at the presentation location in the middle row, and the commercial goods whose score is “4” or less are arranged at the presentation location in the back row.

The calculation of the score for each commercial goods in step S560 may be customizable for each virtual store. For example, the calculation of the score for each commercial goods may be that a score of “+10” is given when there is commercial goods that is compatible with the purchased commercial goods within 1 month, a score of “+5” is given when the time of viewing the commercial goods is longer than 10 seconds, a score of “−5” is given when the purchase price range of the same commercial goods classification is not the same, a score of “+5” is given when the commercial goods has a large inventory, a score of “+5” is given when the commercial goods has less than or equal to one month left until the end of the sale, and a score of “+10” is given when the commercial goods is subject to a sale. The calculation of the score for each commercial goods in step S560 may be set so that the commercial goods expected by the user is arranged at a presentation location with high priority.

The proposal information generating unit 26 generates proposal information for presentation display of commercial goods by using the presentation location of commercial goods determined in step S580. The transmitting unit 30 of the information providing apparatus 10 transmits proposal information to the virtual space display apparatus 11.

Proceeding from step S580 to step S620, the virtual space control unit 78 of the virtual space display apparatus 11, which has received proposal information from the information providing apparatus 10, displays the presented and displayed commercial goods in a virtual store according to the presentation location determined by using the user's preference.

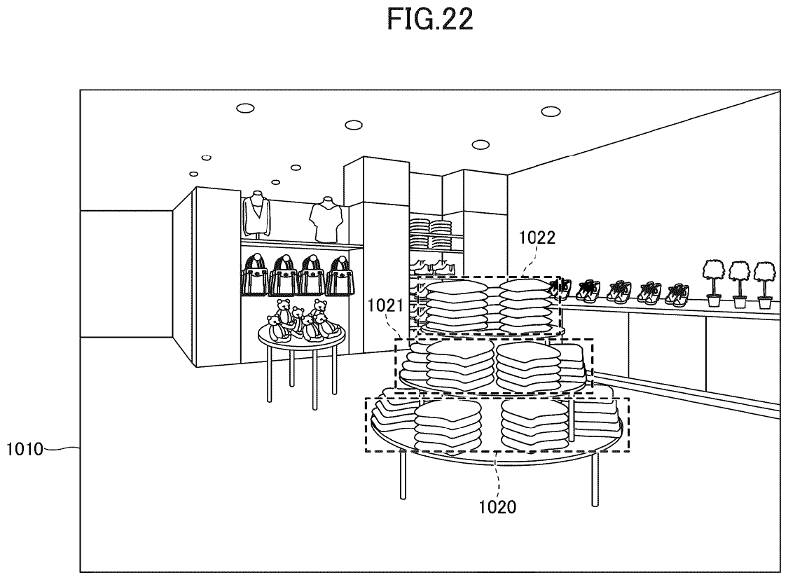

By using the proposal information received from the information providing apparatus 10, the virtual space control unit 78 of the virtual space display apparatus 11 causes the user terminal 13 to display an image of the virtual store where the commercial goods are presented and displayed, as illustrated in FIG. 22, for example.

FIG. 22 is an image diagram of an example of an image of the virtual store displayed on the user terminal. FIG. 22 is an image 1010 of the virtual store where the presentation display of commercial goods is changed by the user operating the user terminal 13. In the image 1010 of the virtual store illustrated in FIG. 22, presentation locations 1020 to 1022 for presenting and displaying commercial goods are set.

For example, if the presentation location 1020 is the front row, the presentation location 1021 is the middle row, and the presentation location 1022 is the back row, the commercial goods for which the item of presentation location has been determined to be in the front row in FIG. 16 are presented and displayed at the presentation location 1020. The commercial goods for which the item of presentation location has been determined to be in the middle row in FIG. 16 are presented and displayed at the presentation location 1021. Furthermore, the commercial goods for which the item of presentation location has been determined to be in the back row in FIG. 16 are presented and displayed at the presentation location 1022.

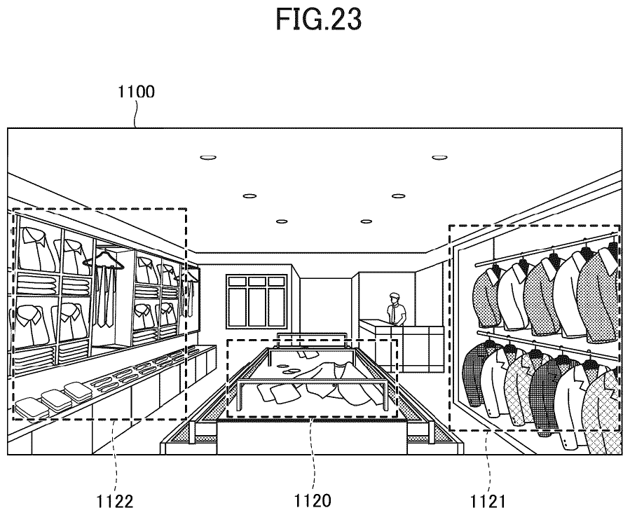

Note that the presentation locations 1020 to 1022 in FIG. 22 are examples, and an image of a virtual store in which commercial goods are presented and displayed, for example, as illustrated in FIG. 23, may be displayed on the user terminal 13. FIG. 23 is an image diagram of an example of an image of a virtual store displayed on the user terminal. FIG. 23 is an image 1100 of a virtual store in which the presentation display of commercial goods is changed by a user operating the user terminal 13. In the image 1100 of the virtual store in FIG. 23, presentation locations 1120 to 1122 for presenting and displaying commercial goods are set.

For example, in FIG. 23, the presentation location 1120 is an example of a presentation location with the highest priority, the presentation location 1122 is an example of a presentation location with the second highest priority, and the presentation location 1121 is an example of a presentation location with the third highest priority. For example, in the example of FIG. 16, commercial goods for which the item of presentation location has been determined to be in the front row are presented and displayed at the presentation location 1120. Furthermore, commercial goods for which the item of presentation location has been determined to be in the middle row in FIG. 16 are presented and displayed at the presentation location 1122. Furthermore, commercial goods for which the item of presentation location has been determined to be in the back row in FIG. 16 are presented and displayed in the presentation location 1121.

As described above, in the information processing system 1 of the present embodiment, the behavior history information of the user in the virtual space can be passed over to the user who uses the virtual space such as a virtual store and a real store while moving, thereby providing proposal information for generating a more appropriate virtual space for the user.

### OTHER EMBODIMENTS

In the first and second embodiments, an example of apparel commercial goods has been described, but the embodiment is not limited to apparel commercial goods. In the first and second embodiments, an example of a user moving between a virtual store and a real store of the same industry in the information processing system 1 has been described, but the embodiment can also be applied to the case of moving between a virtual store and a real store of different industries.

For example, in the information processing system 1 according to the present embodiment, when a user moves between a virtual store and a real store of a home electronics retail store and a large furniture store, the items indicating the user's preference in the user information illustrated in FIG. 6 are changed. For example, in the case of the user information illustrated in FIG. 6, the items of design preference, color preference, and size preference will be changed to items suitable for the commercial goods sold in the home electronics retail store and the large furniture store.

For example, in the information processing system 1 according to the present embodiment, when a user moves between a virtual store and a real store of a home electronics retail store and a large furniture store, the items used to determine the user's preference of the commercial goods information illustrated in FIG. 10 are changed. For example, in the case of the commercial goods information illustrated in FIG. 10, the items of design type, color, and size are changed to items suitable for the commercial goods sold at the home electronics retail store and the large furniture store.

In the first and second embodiments, although the virtual store and the real store displayed on the user terminal 13 before the moving to a store are described as examples of the first virtual space, a virtual space in which commercial goods are not sold, for example, a virtual space in which user information is set or the virtual space in which the user sets an avatar may be included. Furthermore, the virtual store and the real store may be managed by a shopping mall unit constructed/generated on the virtual space, or may be managed by a group unit of some kind.

Each function of the embodiment described above may be implemented by one or more processing circuits. The term “processing circuit” as used herein includes a processor that is programmed to perform each function by software, such as a processor implemented by an electronic circuit, or a device such as an application specific integrated circuit (ASIC), a digital signal processor (DSP), a field programmable gate array (FPGA), or conventional circuit module designed to perform each function described above.

The group of devices described in the examples only illustrates one of a plurality of computing environments for implementing the embodiments disclosed herein. The present invention is not limited by the present embodiment. Further, various omissions, substitutions, changes, and combinations of elements may be made without departing from the gist of the present embodiment.

The information providing apparatus, the information processing system, and the information providing method are not limited to the specific embodiments described in the detailed description, and variations and modifications may be made without departing from the spirit and scope of the present invention.

What is claimed is:

1. An information providing apparatus comprising:
circuitry; and
a memory storing computer-executable instructions that cause the circuitry to execute:
acquiring behavior history information of a user in a first virtual space displayed on a user terminal operated by the user; and
transmitting proposal information based on the behavior history information corresponding to attribute information of the user, as proposal information to be proposed to the user to whom a second virtual space is displayed.

2. The information providing apparatus according to claim 1, wherein the circuitry is further caused to execute:
determining the proposal information by using the behavior history information corresponding to the attribute information of the user.

3. The information providing apparatus according to claim 2, wherein the determining includes
determining preference of the user based on the behavior history information, and
determining the proposal information to be proposed to the user from among commercial goods information associated with the second virtual space, by using the determined preference of the user.

4. The information providing apparatus according to claim 3, wherein
the first virtual space and the second virtual space are virtual stores selling commercial goods, and
the determining of the proposal information includes determining the proposal information to be proposed to the user from among the commercial goods information associated with the commercial goods sold in the second virtual space.

5. The information providing apparatus according to claim 4, wherein the determining includes determining the preference of the user, based on at least one of the behavior history information representing a behavior of the user viewing commercial goods or the behavior history information representing a behavior of the user purchasing commercial goods.

6. The information providing apparatus according to claim 1, wherein the acquiring further includes acquiring the attribute information of the user set in the first virtual space.

7. The information providing apparatus according to claim 1, wherein the circuitry is further caused to execute:
displaying the proposal information in the second virtual space displayed on the user terminal.

8. The information providing apparatus according to claim 1, wherein the behavior history information of the user in the first virtual space further includes the behavior history information of the user in a real space corresponding to the first virtual space.

9. The information providing apparatus according to claim 1, wherein the transmitting includes transmitting the proposal information relating to generation of the second virtual space for the user, based on the behavior history information corresponding to the attribute information of the user.

10. The information providing apparatus according to claim 9, wherein the circuitry is further caused to execute:
determining the proposal information relating to generation of the second virtual space for the user, by using the behavior history information corresponding to the attribute information of the user.

11. The information providing apparatus according to claim 10, wherein the determining includes determining the proposal information relating to generation of the second virtual space for the user, by using preference of the user determined based on the behavior history information.

12. The information providing apparatus according to claim 11, wherein
the first virtual space and the second virtual space are virtual stores selling commercial goods, and
the determining includes determining the proposal information relating to a presentation of the commercial goods displayed in the second virtual space for the user, by using the preference of the user.

13. The information providing apparatus according to claim 12, wherein the determining includes determining the preference of the user, based on at least one of the behavior history information representing a behavior of the user viewing commercial goods or the behavior history information representing a behavior of the user purchasing commercial goods.

14. The information providing apparatus according to claim 12, wherein the circuitry is further caused to execute:
displaying, on the user terminal, the commercial goods in the second virtual space for the user upon changing the presentation of the commercial goods according to the proposal information.

15. The information providing apparatus according to claim 9, wherein the behavior history information of the user in the first virtual space further includes the behavior history information of the user in a real space corresponding to the first virtual space.

16. An information processing system comprising:
an information providing apparatus; and
a user terminal operated by a user communicably connected to the information providing apparatus, wherein
the information providing apparatus includes:
first circuitry; and
a first memory storing computer-executable instructions that cause the circuitry to execute:
acquiring behavior history information of the user in a first virtual space displayed on the user terminal operated by the user; and
transmitting proposal information based on the behavior history information corresponding to attribute information of the user, as proposal information to be proposed to the user to whom a second virtual space is displayed, and wherein
the user terminal includes:
second circuitry; and
a second memory storing computer-executable instructions that cause the circuitry to execute:
displaying the first virtual space, the second virtual space, and the proposal information on a screen.

17. An information providing method executed by an information providing apparatus, the information providing method comprising:
acquiring behavior history information of a user in a first virtual space displayed on a user terminal operated by the user; and
transmitting proposal information based on the behavior history information corresponding to attribute information of the user, as proposal information to be proposed to the user to whom a second virtual space is displayed.
